(19) United States
(12) Patent Application Publication
(10) Pub. No.: US 2013/0013962 A1
(43) Pub. Date: Jan. 10, 2013

(54) COMPUTING DEVICE AND METHOD FOR ANALYZING INTEGRALITY OF SERIAL ATTACHED SCSI SIGNALS

(75) Inventors: HSIEN-CHUAN LIANG, Tu-Cheng (TW); SHEN-CHUN LI, Tu-Cheng (TW); SHOU-KUO HSU, Tu-Cheng (TW); JUI-HSIUNG HO, Tu-Cheng (TW); CHENG-HSIEN LEE, Tu-Cheng (TW); CHUN-NENG LIAO, Tu-Cheng (TW)

(73) Assignee: HON HAI PRECISION INDUSTRY CO., LTD., Tu-Cheng (TW)

(21) Appl. No.: 13/479,271

(22) Filed: May 24, 2012

(30) Foreign Application Priority Data
Jul. 6, 2011 (TW) 100123769

(51) Int. Cl. G06F 11/28

(52) U.S. Cl. 714/43; 714/E11.178

(57) ABSTRACT

In a method for analyzing integrality of serial attached SCSI (SAS) signals using a computing device, the computing device connects to a signal measuring device and an electronic device. A group of test parameters, an intensity grade of a SAS signal, and a total number are set for evaluating integrality of the SAS signal. The intensity grade of the SAS signal is adjusted through an SAS interface of the electronic device. The signal measuring device measures test parameters of the SAS signal, and a test number is recorded when the test parameters of the SAS are measured. The method analyzes the integrality of the SAS signal to find an optimal SAS signal when the test number equals the total number, and determines an intensity grade of the optimal SAS signal as a driving parameter of the SAS interface.

### BACKGROUND

1. Technical Field

Embodiments of the present disclosure relate to signal analysis systems and methods, and particularly to a computing device, a storage medium, and a method for analyzing integrality of a serial attached small computer system interface (SCSI) signal (hereinafter “SAS signal”) transmitted from an SAS interface of an electronic device.

2. Description of related art

Serial attached SCSI (SAS) interfaces are used in electronic devices to connect a storage device (e.g., a SATA hard disk drive) to a processor included in the electronic devices. The SATA hard disk drive may generate SAS signals when data is exchanged between the SATA hard disk drive and the processor, and then the SAS signals are transmitted to the processor through the SAS interface. Usually, the SAS signal may be measured to evaluate whether the SAS interface is workable. However, such test operation may be performed by manpower, and thus a lot of manual work is required to test integrality of the SAS signal. The efficiency and accuracy of the test operation cannot be ensured.

### BRIEF DESCRIPTION OF THE DRAWINGS

FIG. 1 is a block diagram of one embodiment of a computing device including an SAS signal analysis system.

FIG. 2 is a flowchart of one embodiment of a method for analyzing integrality of SAS signal using the computing device of FIG. 1.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean at least one.

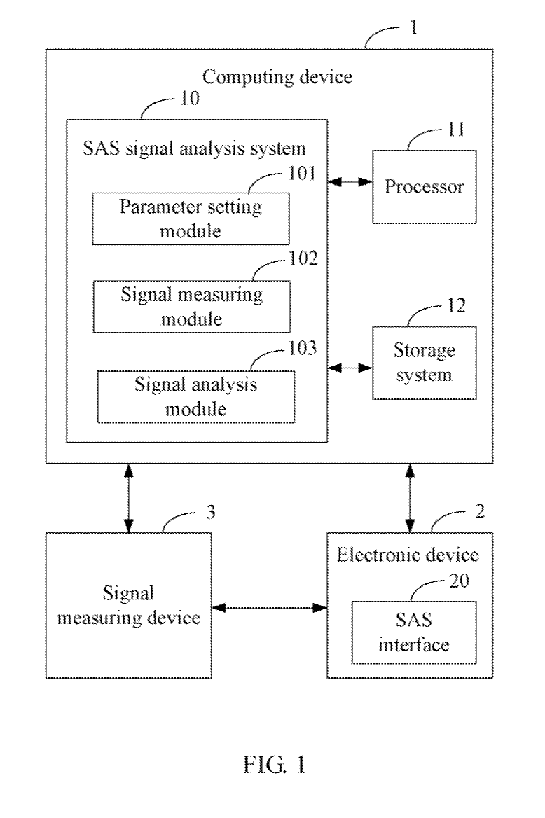

FIG. 1 is a block diagram of one embodiment of a computing device 1 including a serial attached SCSI (SAS) signal analysis system 10. In the embodiment, the computing device 1 may further include at least one processor 11 and a storage system 12. The SAS signal analysis system 10 may include a plurality of functional modules that are stored in the storage system 12 and executed by the at least one processor 11. It is understood that FIG. 1 is only one example of the computing device 1 that includes more or fewer components than those shown in the embodiment, or have a different configuration of the various components.

In one embodiment, the computing device 1 electronically connects to an electronic device 2 through a component object mode (COM) port, and connects to a signal measuring device 3 through a first general purpose interface bus (GPIB). The electronic device 2 electronically connects to the signal measuring device 3 through a second GPIB. In the embodiment, the electronic device 2 may be a computer or a data processing device that includes an SAS interface 20, which is used to transmit one or more SAS signals to the computing device 1 through the COM port. The signal measuring device 3 may be an oscilloscope that is used to measure a plurality of test parameters from a SAS signal transmitted from the SAS interface 20.

The SAS signal analysis system 10 obtains the SAS signals transmitted from the SAS interface 20, measures one or more test parameters of the SAS signals, and analyzes integrality of the SAS signal to determine one of the test parameters as a driving parameter of the SAS interface 20. In one embodiment, the test parameters may include a phase value, a jitter value, a period value, a frequency value, a rising time and a falling time of each of the SAS signals.

In one embodiment, the storage system 12 may be an internal storage system, such as a random access memory (RAM) for temporary storage of information, and/or a read only memory (ROM) for permanent storage of information. In some embodiments, the storage system 12 may also be an external storage system, such as an external hard disk, a storage card, or a data storage medium.

In one embodiment, the SAS signal analysis system 10 includes a parameter setting module 101, a signal measuring module 102, and a signal analysis module 103. The modules 101-103 may comprise computerized instructions in the form of one or more programs that are stored in the storage system 12 and executed by the at least one processor 11. In the present disclosure, the word “module,” as used herein, refers to logic embodied in hardware or firmware, or to a collection of software instructions, written in a program language. In one embodiment, the program language may be Java, C, or assembly. One or more software instructions in the modules may be embedded in firmware, such as an EPROM. The modules described herein may be implemented as either software and/or hardware modules and may be stored in any type of non-transitory computer-readable medium or other storage device. Some non-limiting examples of non-transitory computer-readable medium include CDs, DVDs, flash memory, and hard disk drives.

The parameter setting module 101 sets a group of test parameters for evaluating integrality of a SAS signal, and predefines a standard value for each of the test parameters. As mentioned above, the test parameters may include a phase value, a jitter value, a period value, a frequency value, a rising time and a falling time of each of the SAS signals. The parameter setting module 101 further sets an intensity grade of the SAS signal and a total number (denoted as “X”) of times for testing the integrality of the SAS signal. In one embodiment, the intensity grade of the SAS signal includes a phase grade, a jitter grade, and a signal emphasis grade of the SAS signal. If each grade is defined as a grade range from one grade to five grades, the total number may be set as X=5*5*5=125 times. If each grade is defined as a grade range from one grade to seven grades, the total number may be set as X=7*7*7=343 times.

The signal measuring module 102 adjusts the intensity grade of the SAS signal through the SAS interface 20 of the electronic device 2, and measures an actual value of each of the test parameters of the SAS signal using the signal measuring device 3. In one embodiment, the signal measuring module 102 enhances the SAS signal by increasing the intensity grade of the SAS signal, and weakens the SAS signal by decreasing the intensity grade of the SAS signal.

The signal measuring module 102 further records the actual values of the test parameters into a predefined file, such as an EXECL format file, and stores the predefined file into the storage system 12. The signal measuring module 102 increases a test number (denoted as “Y”) by one when the test parameters of the SAS are measured, i.e., Y=Y+1, and determines whether the test number is equal to the total number.

The signal analysis module 103 analyzes the integrality of the SAS signal to find an optimal SAS signal by comparing the actual value with the standard value of each of the test parameters when the test number is equal to the total number. In the embodiment, the optimal SAS signal has a minimum jitter value or a minimum phase value. The signal analysis module 103 further determines an intensity grade of the optimal SAS signal as a driving parameter of the SAS interface 20, generates an analysis report of the SAS signal according to the test parameters of the SAS signal, and stores the analysis report of the SAS signal into the storage system 12.

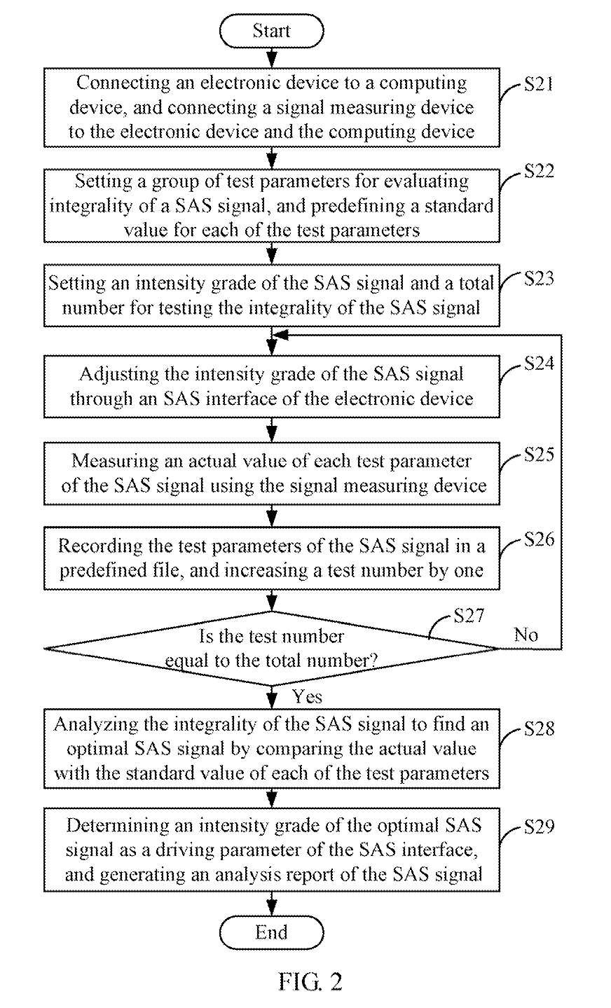

FIG. 2 is a flowchart of one embodiment of a method for analyzing integrality of SAS signal using the computing device 1 of FIG. 1. In the embodiment, the method can obtain a SAS signal transmitted from the SAS interface 20 of the electronic device 2, measures one or more test parameters of the SAS signal, and analyzes integrality of the SAS signal to determine one of the parameters as a driving parameter of the SAS interface 20. Depending on the embodiment, additional blocks may be added, others removed, and the ordering of the blocks may be changed.

In block S21, the test operator electronically connects the computing device 1 to the electronic device 2 through a COM port, and connects to the signal measuring device 3 through a first GPIB, and connects the electronic device 2 to the signal measuring device 3 through a second GPIB.

In block S22, the parameter setting module 101 sets a group of test parameters for evaluating integrality of a SAS signal transmitted from the SAS interface 20, predefines a standard value for each of the test parameters. In one embodiment, the test parameters may include a phase value, a jitter value, a period value, a frequency value, a rising time and a falling time of the SAS signal.

In block S23, the parameter setting module 101 sets an intensity grade of the SAS signal and a total number (denoted as “X”) for testing the integrality of the SAS signal. In one embodiment, the intensity grade of the SAS signal includes a phase grade, a jitter grade, and a signal emphasis grade of the SAS signal. If each grade is defined as a grade range from one grade to five grades, the total number may be set as X=5*5*5=125 times. If each grade is defined as a grade range from one grade to seven grades, the total number may be set as X=7*7*7=343 times.

In block S24, the signal measuring module 102 adjusts the intensity grade of the SAS signal through the SAS interface 20 of the electronic device 2. In one embodiment, the signal measuring module 102 enhances the SAS signal by increasing the intensity grade of the SAS signal, and weakens the SAS signal by decreasing the intensity grade of the SAS signal.

In block S25, the signal measuring module 102 measures an actual value of each of the test parameters of the SAS signal using the signal measuring device 3.

In block S26, the signal measuring module 102 records the actual value of the test parameters of the SAS signal in a predefined file, such as an EXECL format file, and stores the predefined file into the storage system 12.

In block S27, the signal measuring module 102 increases a test number (denoted as “Y”) by one when the test parameters of the SAS are measured, i.e., Y=Y+1, and determines whether the test number is equal to the total number. If the test number is equal to the total number, block S28 is implemented. Otherwise, if the test number is not equal to the total number, block S24 is repeated.

In block S28, the signal analysis module 103 analyzes the integrality of the SAS signal to find an optimal SAS signal by comparing the actual value with the standard value of each of the test parameters when the test number is equal to the total number. In the embodiment, the optimal SAS signal has a minimum jitter value or a minimum phase value.

In block S28, the signal analysis module 103 determines an intensity grade of the optimal SAS signal as a driving parameter of the SAS interface 20, generates an analysis report of the SAS signal according to the test parameters of the SAS signal, and stores the analysis report of the SAS signal into the storage system 12.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A computing device, the computing device electronically connected to a signal measuring device and an electronic device, the computing device comprising:
a storage system;
at least one processor; and
one or more programs stored in the storage system and executable by the at least one processor, the one or more programs comprising:
a parameter setting module that sets a group of test parameters used for evaluating integrality of a serial attached SCSI (SAS) signal, predefines a standard value for each of the test parameters, and sets an intensity grade of the SAS signal and a total number of times for testing the integrality of the SAS signal;
a signal measuring module that adjusts the intensity grade of the SAS signal through an SAS interface of the electronic device, measures an actual value of each of the test parameters of the SAS signal using the signal measuring device, and records a test number when the actual values of the test parameters are recorded into a predefined file; and
a signal analysis module that finds an optimal SAS signal by comparing the actual value of each of the test parameters with standard value of each of the test parameters when the test number is equal to the total number, and determines an intensity grade of the optimal SAS signal as a driving parameter of the SAS interface.

2. The computing device according to claim 1, wherein the signal analysis module further generates an analysis report of the SAS signal according to the test parameters of the SAS signal, and stores the analysis report of the SAS signal into the storage system.

3. The computing device according to claim 1, wherein the computing device electronically connects to the electronic device through a component object mode (COM) port and connects to the signal measuring device through a first general purpose interface bus (GPIB), and the electronic device electronically connects to the signal measuring device through a GPIB.

4. The computing device according to claim 1, wherein the signal measuring device is an oscilloscope that is used to measure the test parameters from the SAS signal transmitted from the SAS interface.

5. The computing device according to claim 1, wherein the signal measuring module enhances the SAS signal by increasing the intensity grade of the SAS signal, and weakens the SAS signal by decreasing the intensity grade of the SAS signal.

6. The computing device according to claim 1, wherein the test parameters comprise a phase value, a jitter value, a period value, a frequency value, a rising time and a falling time of the SAS signal.

7. A method for analyzing integrality of serial attached SCSI (SAS) signals using a computing device, the computing device electronically connected to a signal measuring device and an electronic device, the method comprising:
setting a group of test parameters for evaluating integrality of a SAS signal, and predefining a standard value for each of the test parameters;
setting an intensity grade of the SAS signal and a total number of times for testing the integrality of the SAS signal;
adjusting the intensity grade of the SAS signal through an SAS interface of the electronic device;
measuring an actual value of each of the test parameters of the SAS signal using the signal measuring device, and recording a test number when the actual values of the test parameters are recorded into a predefined file;
finding an optimal SAS signal by comparing the actual value of each of the test parameters with the standard value of each of the test parameters when the test number is equal to the total number; and
determining an intensity grade of the optimal SAS signal as a driving parameter of the SAS interface.

8. The method according to claim 7, further comprising:
generating an analysis report of the SAS signal according to the test parameters of the SAS signal; and
storing the analysis report into a storage system of the computing device.

9. The method according to claim 7, wherein the computing device electronically connects to the electronic device through a component object mode (COM) port, and connects to a signal measuring device through the first general purpose interface bus (GPIB), and the electronic device electronically connects to the signal measuring device through a second GPIB.

10. The method according to claim 7, wherein the signal measuring device is an oscilloscope that is used to measure the test parameters from the SAS signal transmitted from the SAS interface.

11. The method according to claim 7, wherein the SAS signal is enhanced by increasing the intensity grade of the SAS signal, and the SAS signal is weakened by decreasing the intensity grade of the SAS signal.

12. The method according to claim 7, wherein the test parameters comprise a phase value, a jitter value, a period value, a frequency value, a rising time and a falling time of the SAS signal.

13. A non-transitory computer-readable storage medium having stored thereon instructions that, when executed by at least one processor of a computing device, causes the computing device to perform a method for analyzing integrality of serial attached SCSI (SAS) signals, the computing device electronically connected to a signal measuring device and an electronic device, the method comprising:
setting a group of test parameters for evaluating integrality of a SAS signal, and predefining a standard value for each of the test parameters;
setting an intensity grade of the SAS signal and a total number of times for testing the integrality of the SAS signal;
adjusting the intensity grade of the SAS signal through an SAS interface of the electronic device;
measuring an actual value of each of the test parameters of the SAS signal using the signal measuring device, and recording a test number when the actual values of the test parameters are recorded into a predefined file;
finding an optimal SAS signal by comparing the actual value of each of the test parameters with the standard value of each of the test parameters when the test number is equal to the total number; and
determining an intensity grade of the optimal SAS signal as a driving parameter of the SAS interface.

14. The storage medium according to claim 13, wherein the method further comprises:
generating an analysis report of the SAS signal according to the test parameters of the SAS signal; and
storing the analysis report into a storage system of the computing device.

15. The storage medium according to claim 13, wherein the computing device electronically connects to the electronic device through a component object mode (COM) port, and connects to the signal measuring device through a first general purpose interface bus (GPIB), and the electronic device electronically connects to the signal measuring device through a GPIB.

16. The storage medium according to claim 13, wherein the signal measuring device is an oscilloscope that is used to measure the test parameters from the SAS signal transmitted from the SAS interface.

17. The storage medium according to claim 13, wherein the SAS signal is enhanced by increasing the intensity grade of the SAS signal, and the SAS signal is weakened by decreasing the intensity grade of the SAS signal.

18. The storage medium according to claim 13, wherein the test parameters comprise a phase value, a jitter value, a period value, a frequency value, a rising time and a falling time of the SAS signal.
